(19) United States
(12) Patent Application Publication
(10) Pub. No.: US 2019/0025994 A1
(43) Pub. Date: Jan. 24, 2019

(54) RECORDING MEDIUM ON WHICH DISPLAY CONTROL PROGRAM IS RECORDED, DISPLAY CONTROL METHOD, AND INFORMATION PROCESSING APPARATUS

(71) Applicant: FUJITSU LIMITED, Kawasaki-shi (JP)

(72) Inventor: Akihiro Miyamoto, Minato (JP)

(73) Assignee: FUJITSU LIMITED, Kawasaki-shi (JP)

(21) Appl. No.: 16/144,041

(22) Filed: Sep. 27, 2018

Related U.S. Application Data
(63) Continuation of application No. PCT/JP2016/060094, filed on Mar. 29, 2016.

(51) Int. Cl. G06F 3/0482; G06F 3/0488; G06F 3/0484

(52) U.S. Cl. CPC G06F 3/0482; G06F 3/04845; G06F 3/04883

(57) ABSTRACT

A non-transitory computer-readable recording medium recording a display control program which causes a computer to execute a processing, the processing includes: referring, when receiving a request for display of satisfied content that satisfies a condition, to a storage which stores user identification information, and download history information on content or registration history information on the content in association with each other, specifying content that is associated with user identification information on a source of the request for display, displaying the specified content in a simple display, from among the satisfied content, and displaying other content on a normal display, on a display area that is greater than a display area for the simple display.

### CROSS-REFERENCE TO RELATED APPLICATION

This application is a continuation application of International Application PCT/JP2016/060094 filed on Mar. 29, 2016 and designated the U.S., the entire contents of which are incorporated herein by reference.

### FIELD

The embodiments discussed herein are related to a recording medium on which a display control program is recorded, a display control method, and a display control apparatus.

### BACKGROUND

Content such as data or a program is purchased and is downloaded on a personal computer (PC) or the like.

A related technology is disclosed in Japanese Laid-open Patent Publication No. 2014-014094.

### SUMMARY

According to an aspect of the embodiment, a non-transitory computer-readable recording medium recording a display control program which causes a computer to execute a processing, the processing includes: referring, when receiving a request for display of satisfied content that satisfies a condition, to a storage which stores user identification information, and download history information on content or registration history information on the content in association with each other, specifying content that is associated with user identification information on a source of the request for display, displaying the specified content in a simple display, from among the satisfied content, and displaying other content on a normal display, on a display area that is greater than a display area for the simple display.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an example of a display control system;

FIG. 2 is an example of a hardware configuration of a terminal device;

FIG. 3 is an example of a hardware configuration of a server apparatus;

FIG. 4 is an example of a functional block diagram of the terminal device and the server apparatus;

FIG. 5 is an example of a content master storage unit;

FIG. 6 is an example of a history storage unit;

FIG. 7 is another example of the functional block diagram of the terminal device and the server apparatus;

FIG. 8 is a flowchart illustrating an example of processing that is performed by the terminal device;

FIG. 9 is an example of a content list screen;

FIG. 10 is an example of a download screen;

FIG. 11 is another example of the content list screen;

FIG. 12 is a diagram for describing an example of an operation with respect to content that is controlled to be simply displayed;

FIG. 13 is a diagram for describing an example of a first operation with respect to the content that is controlled to be simply displayed;

FIG. 14 is an example of the content list screen that is displayed after the first operation;

FIG. 15 is a diagram for describing an example of a second operation with respect to the content that is controlled to be simply displayed;

FIG. 16 is an example of the content list screen that is displayed after the second operation;

FIG. 17 is another example of the content list screen; and

FIG. 18 is a diagram for describing an example of processing including and up to controlling content, which is controlled to be normally displayed, to be simply displayed.

### DESCRIPTION OF EMBODIMENTS

For example, in a case where many items of content are present and content is not displayed on one screen, the content that is not displayed is displayed by performing a scroll operation.

For example, in most cases, a screen of a smart device, such as a smartphone or a tablet terminal, is small compared with a screen of a PC. Therefore, in a case where many items of content are not displayed, a user has to perform the scroll operation many times until target content is found as a result of conducting a search among the many items of content.

For example, in a case where the user wants to display content that is not yet displayed, among the many items of content, as target content, there is a likelihood that the user will not readily find the target content due to the presence of the content that is already displayed. In this case, there is a likelihood that the user will perform the scroll operation time and time again in order to find the target content.

For example, a display control method of preferentially displaying content that is neither downloaded nor registered, or the like may be provided.

Embodiments of the present disclosure will be described below with reference to the drawings.

### First Embodiment

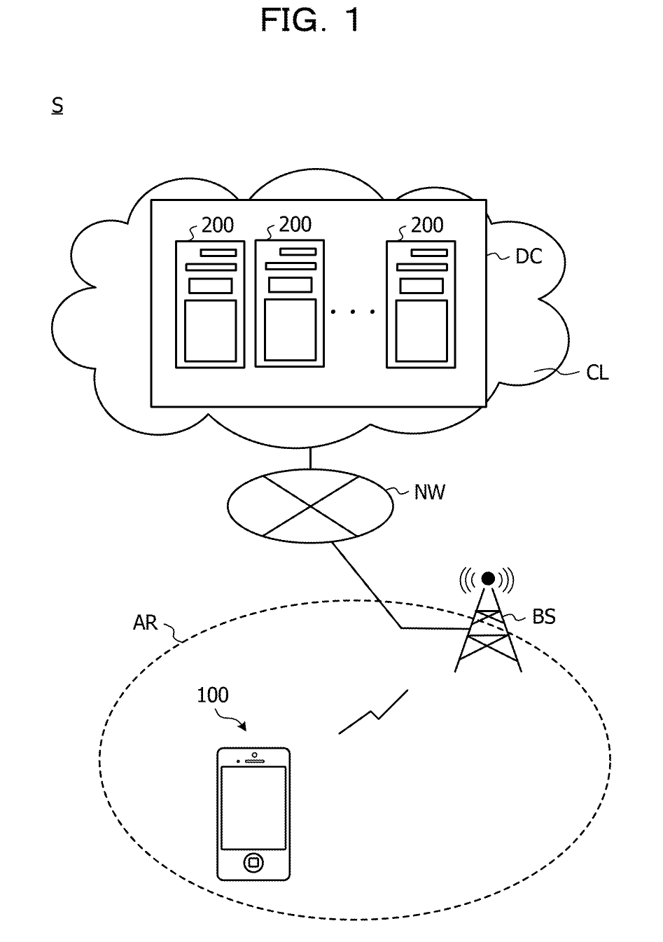

FIG. 1 is a diagram for describing an example of a display control system S. The display control system S includes a terminal device 100 and a server apparatus 200. In FIG. 1, as an example of the terminal device 100, a smartphone is illustrated, and in the case of a mobile terminal, no limitation is imposed. The terminal device may be a smart device, such as a tablet terminal or a smart watch, a wearable computer, such as a head-mounted display, or the like.

The terminal device 100 and the server apparatus 200 are connected to each other via a wired network NW1, and a wireless network that will be described below. Examples of the wired network NW1 include a communication network such as the Internet. Examples of the wireless network include a communication network such as a mobile telephone network. Therefore, in a case where the terminal device 100 is included within an area AR where wireless communication is available, the terminal device 100 can communicate with the server apparatus 200.

The terminal device 100 receives various pieces of information that are transmitted from the server apparatus 200 or transmits various pieces of information to the server apparatus 200. For example, when the terminal device 100 transmits a request for display that makes a request for display content, to the server apparatus 200 that stores a plurality of items of content, the server apparatus 200 receives a request for the display.

For more detail, the request for the display that is transmitted by the terminal device 100 is received by mobile base station BS via the wireless network. The mobile base station BS transfers the received request for the display toward the server apparatus 200. The request for the display that is transferred by the mobile base station BS is received by the server apparatus 200 via the wired network NW1. When receiving the request for the display, the server apparatus 200 transmits a list of items of content in accordance with the request for the toward the terminal device 100. Specifically, the server apparatus 200 starts to download the list of items of content.

Moreover, examples of the content described above include an electronic file such as a data file or a program file. Examples of the data file include a document file including document data, an image file including moving image data or still image data, an audio file including audio data, and the like. Examples of the program file include an application file including an application program, and the like. Moreover, in some cases, the application program is also referred to simply as an application.

Furthermore, in FIG. 1, the server apparatus 200 is deployed within a data center DC on a cloud CL, but, for example, if the mobile base station BS is replaced with an access point and a local area network (LAN) as the wired network NW1 is used, the server apparatus 200 may be connected to the LAN.

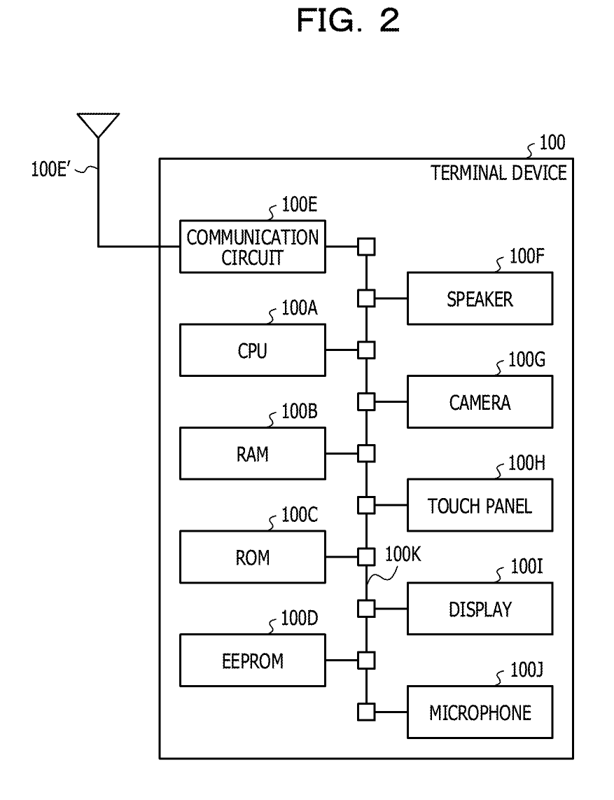

Subsequently, a hardware configuration of the terminal device 100 will be described with reference to FIG. 2.

FIG. 2 is an example of the hardware configuration of the terminal device 100. As illustrated in FIG. 2, the terminal device 100 includes a central processing unit (CPU) 100A, a random access memory (RAM) 100B, a read only memory (ROM) 100C, an electrically erasable programmable read only memory (EEPROM) 100D, and a communication circuit 100E. An antenna 100E′ is connected to the communication circuit 100E. Instead of the communication circuit 100E, the CPU may be used that realizes a communication function.

Furthermore, the terminal device 100 includes a speaker 100F, a camera 100G, a touch panel 100H, a display 100I, and a microphone 100J. The camera 100G, for example, includes an optical system, such as an imaging element, that a complementary metal oxide semiconductor (CMOS) or a charge coupled device (CCD). The CPU 100A to the microphone 100J are connected by an internal bus 100K to each other. At least the CPU 100A to the RAM 100B cooperate with each other, and thus a computer is realized.

A program that is stored in the ROM 100C or the EEPROM 100D is stored by the CPU 100A in the RAM 100B. The stored program is executed by the CPU 100A, and thus, various functions, which will be described below, are realized, and various types of processing are realized. Moreover, the program may be set to be in accordance with a flowchart that will be described below.

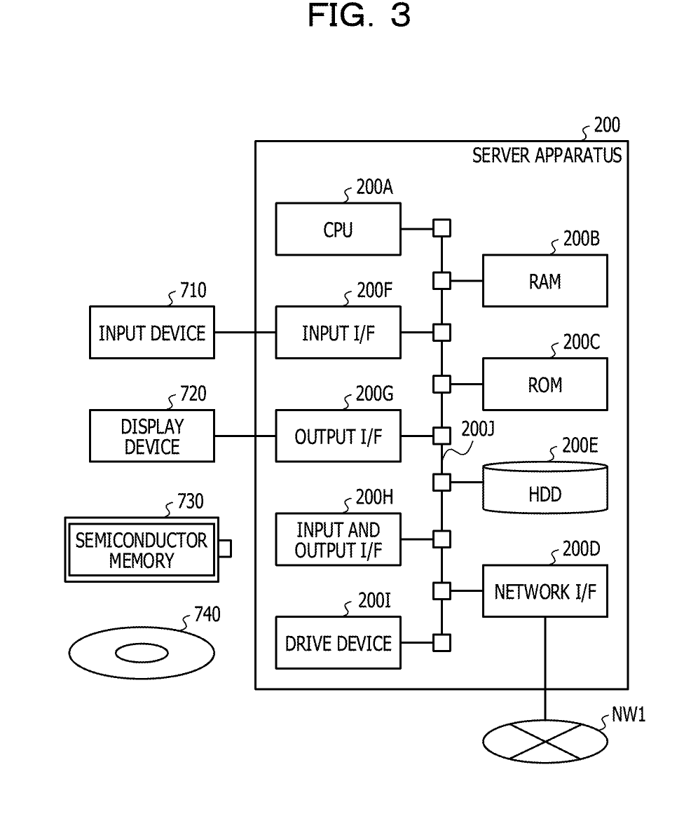

Subsequently, a hardware configuration of the server apparatus 200 will be described with reference to FIG. 3.

FIG. 3 is an example of a hardware configuration of the server apparatus 200. As illustrated in FIG. 3, the server apparatus 200 includes a CPU 200A, a RAM 200B, a ROM 200C, or a network interface (I/F) 200D, or any combination thereof. The server apparatus 200 may include at least one of a hard disk drive (HDD) 200E, an input I/F 200F, an output I/F 200G, an input and output I/F 200H, and a drive device 2001, as occasion demands. The CPU 200A to the drive device 2001 are connected by an internal bus 200J to each other. At least the CPU 200A to the RAM 200B cooperate with each other, and thus a computer is realized.

An input device 710 is connected to the input I/F 200F. Examples of the input device 710 include a keyboard, a mouse, and the like. A display device 720 is connected to the output I/F 200G. Examples of the display device 720 include a liquid crystal display. A semiconductor memory 730 is connected to the input and output I/F 200H. Examples of the semiconductor memory 730 include a universal serial bus (USB) memory, a flash memory, and the like. The input and output I/F 200H reads a program or data that is stored in the semiconductor memory 730. The input I/F 200F and the input and output I/F 200H each include, for example, a USB port. The output I/F 200G includes, for example, a display port.

A portable recording medium 740 is inserted into the drive device 200. Examples of the portable recording medium 740 include a compact disc (CD)-ROM, a digital versatile disc (DVD), and the like. The drive device 2001 reads a program or data that is recorded on the portable recording medium 740. The network I/F 200D includes, for example, a port and a physical layer chip (PHY chip). The server apparatus 200 is connected to the wired network NW1 via the network I/F 200D.

A program that is stored in the ROM 200C or the HDD 200E is stored by the CPU 200A in the RAM 200B described above. A program that is recorded on the portable recording medium 740 is stored by the CPU 200A in the RAM 200B. A program that is stored is executed by the CPU 200A, and thus the server apparatus 200 realizes various functions that will be described and performs various types of processing. Moreover, the program may be set to in accordance with a flowchart that will be described below.

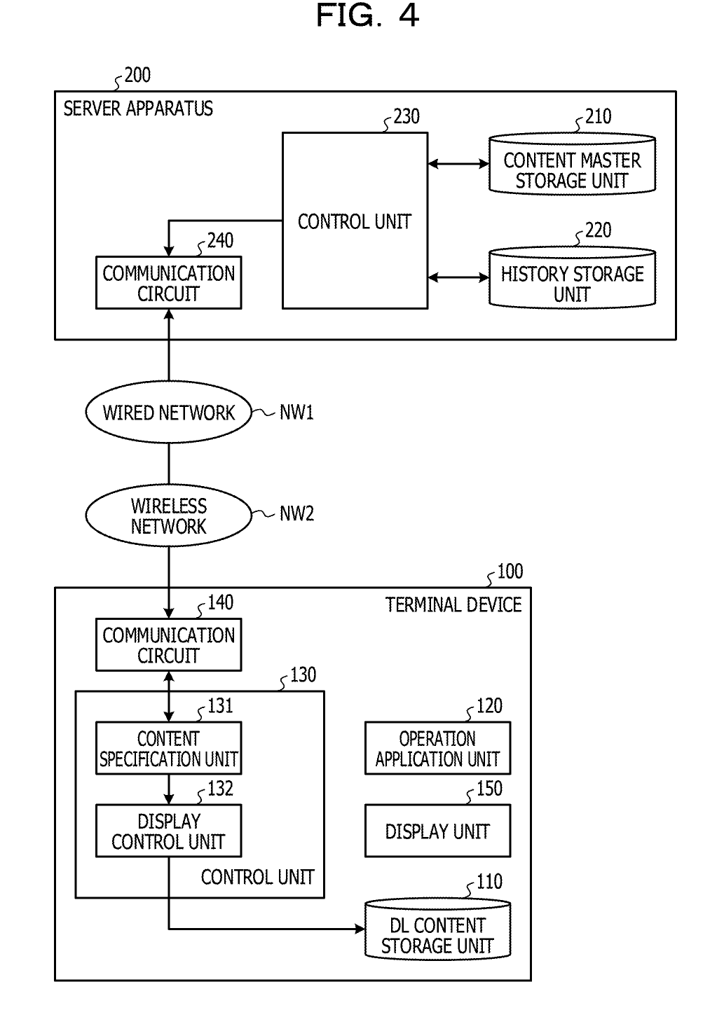

Next, a function of each of the terminal device 100 and the server apparatus 200 will be described with reference to FIGS. 4 to 6.

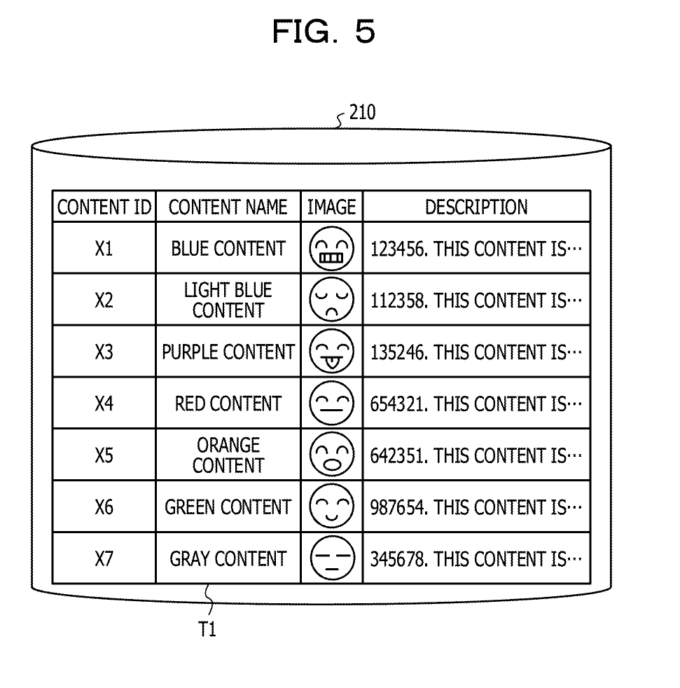

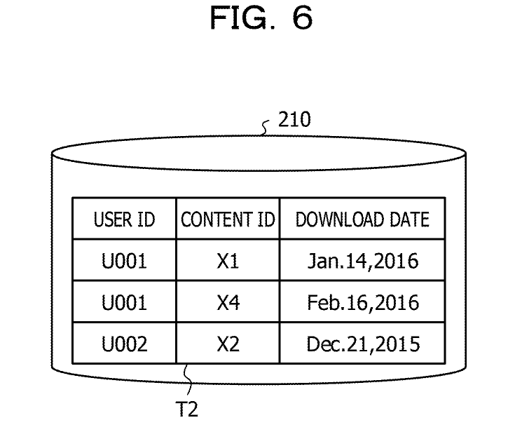

FIG. 4 is an example of a functional block diagram of the terminal device 100 and the server apparatus 200. FIG. 5 is an example of a content master storage unit 210. FIG. 6 is an example of a history storage unit 220. First, the terminal device 100 will be described. The terminal device 100 includes a download (DL) content storage unit 110, an operation application unit 120, a control unit 130 as a display control device, a communication unit 140, and a display unit 150. Furthermore, the control unit 130 includes a content specification unit 131 and a display control unit 132.

Examples of the DL content storage unit 110 here include the EEPROM 100D described above. Examples of the operation application unit 120 include the touch panel 100H. Examples of the control unit 130 include the CPU 100A described above. Examples of the communication unit 140 include the communication circuit 100E and the antenna 100E′, which are described above. Examples of the display unit 150 include the liquid crystal display 100I described above.

Content that is downloaded is stored in the DL content storage unit 110. An electronic folder in which a plurality of items of content are registered for categorization and organization may be stored in the DL content storage unit 110, and content that is downloaded may be stored in the electronic folder. Examples of the electronic folder include a favorite folder in which user's favorite content is registered, and the like.

Various operations are applied by the user on the operation application unit 120 using his/her finger or a touch pen (or a stylus pen). For example, an operation that makes a request for display of content which satisfies a prescribed search condition is applied on the operation application unit 120. Examples of the prescribed search condition include a condition for conducting a search for specific content among items of content that are stored in the server apparatus 200, using a keyword, and the like. When the operation that makes a request for the display of the content is applied on the operation application unit 120, the operation application unit 120 transmits a user ID to the content specification unit 131, with the user ID being included in the request for the display of the content that satisfies the search condition. Moreover, the user ID is stored in a user ID storage unit that is included in the terminal device 100, which is not illustrated, and the operation application unit 120 acquires the user ID from the user ID storage unit and includes the acquired user ID in the request for the display.

When receiving the request for the display, the content specification unit 131 refers to the content master storage unit 210 that will be described, using the search condition, and then downloads a list of items of content that satisfy the search condition. Furthermore, when receiving the request for the display, the content specification unit 131 refers to the history storage unit 220 that will be described, and then specifies a content ID that is associated with the user ID of a display request source. For example, the content specification unit 131 transmits the user ID that is included in the request for the display, to the server apparatus 200 via the communication unit 140. The server apparatus 200 refers to the history storage unit 220 based on the user ID, and then specifies the content ID that is associated with the user ID. The server apparatus 200 transmits the specified content ID toward the terminal device 100. The content specification unit 131 receives the content ID that is transmitted from the server apparatus 200 and goes by way of the communication unit 140, and specifies the content ID that is associated with the user ID of the display request source. The content specification unit 131 transmits the downloaded content and the content ID to the display control unit 132.

The display control unit 132 receives the content and the specified content ID, which are transmitted from the content specification unit 131. When displaying the content that satisfies the search condition, on the display unit 150, the display control unit 132 performs control that sets the display of the content including the specified content ID to be simple display, among the items of content that satisfy the search condition. Furthermore, when displaying the content that satisfies the search condition, on the display unit 150, the display control unit 132 performs control that sets display of content other than the content including the specified content ID to be normal display, a display area for which is larger than that for the simple display. Accordingly, when the content is displayed, the content including the specified content ID and any other content are displayed on the display unit 150 using the simple display and the normal display, respectively.

Next, the server apparatus 200 will be described. The server apparatus 200 includes the content master storage unit 210, the history storage unit 220, a control unit 230, and a communication unit 240. As described above, the server apparatus 200 is connected to the terminal device 100 via the wired network NW1 and a wireless network NW2.

Examples of the content master storage unit 210 and the history storage unit 220 here include the HDD 200E described above. Examples of the control unit 230 include the CPU 200A described above. Examples of the communication unit 240 include the network I/F 200D described above.

Original content that is available before performing reproduction or processing is stored in the content master storage unit 210. For more detail, as illustrated in FIG. 5, the content master storage unit 210 manages each item of content using a content table T1. Each item of content includes the content ID, a content title, an image, and a description as constituent elements. The content ID denotes identification information for identifying content. The content title denotes a title of content. Then image denotes a thumbnail image of content. The description denotes a sentence expressing a detail of content. For example, when “content title=color content” is designated as a prescribed search condition, all items of content are extracted that are managed with the content table T1.

History relating to history of content is stored in the history storage unit 220. For more detail, as illustrated in FIG. 6, the history storage unit 220 manages various pieces of history information with a DL management table T2. Each piece of history information includes the user ID, the content ID, and a download date as constituent elements. Instead of the download date, a registration date at which content is registered in the favorite folder described above may be set to be a constituent element. The user ID denotes identification information for identifying a user. The content ID, as described above, denotes the identification information for identifying content. The download data denotes a date at which content is downloaded. In this manner, the user ID and history information relating to the download of content or history relating to the registration of content are stored in an associated manner in the history storage unit 220. Therefore, when the user ID and the content ID are specified, a download date of, or a registration date, of content associated with the content ID can be checked.

The control unit 230 receives the user ID that is transmitted from the terminal device 100 and goes by way of the communication unit 240. The control unit 230 refers to the history storage unit 220 based on the user ID, and then specifies the content ID that is associated with the user ID. The control unit 230 transmits the specified content ID toward the terminal device 100. Furthermore, in a case where the search condition is transmitted from the terminal device 100, the control unit 230 receives the search condition that goes by way of the communication unit 240. When receiving the search condition, the control unit 230 refers to the content master storage unit 210 using the search condition, and then extracts the content that satisfies the search condition. When extracting the content, the control unit 230 starts to download a list of items of extracted content onto the terminal device 100.

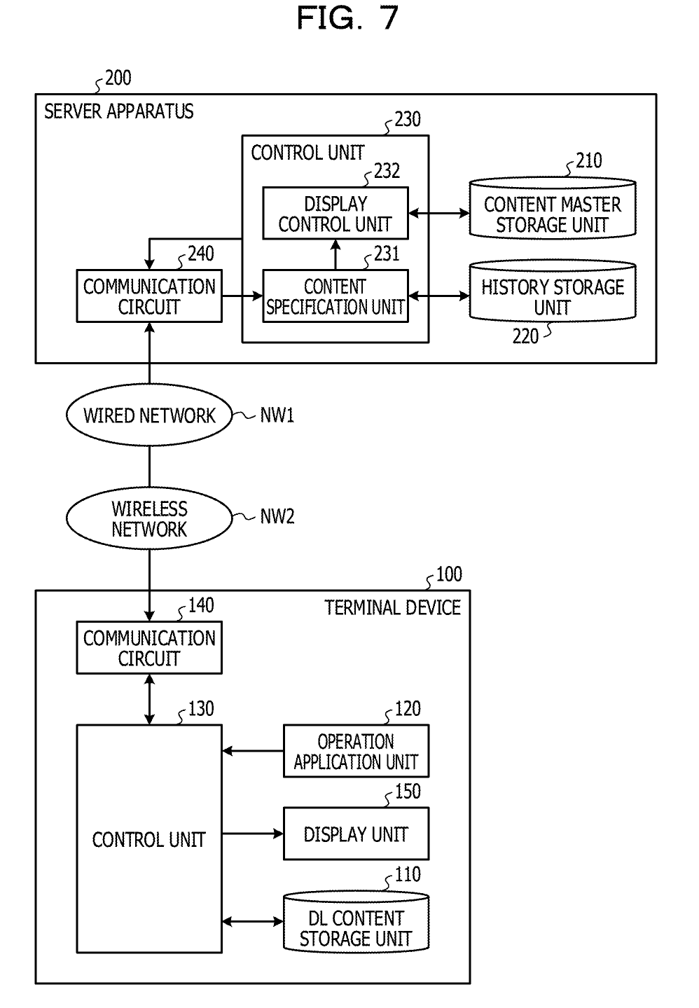

FIG. 7 is another example of a functional block diagram of the terminal device 100 and the server apparatus 200.

As illustrated in FIG. 7, the control unit 230 may include a content specification unit 231 that has the same function as the content specification unit 131 described above, and a display control unit 232 that has the same function as the display control unit 132 described above. In this case, when receiving the request for the display that is transmitted from the operation application unit 120, the control unit 130 of the terminal device 100 transmits the received request for the display toward the server apparatus 200. The request for the display goes by way of the communication unit 140 and the communication unit 240 and reaches the content specification unit 231.

The content specification unit 231 specifies the content ID based on the user ID that is included in the request for the display. Furthermore, when the content specification unit 231 transfers the request for the display and the specified content ID to the display control unit 232, the display control unit 232 refers to the content master storage unit 210 and then extracts the content that satisfies the search condition. The display control unit 232 transmits the list of items of extracted content and the specified content ID toward the terminal device 100.

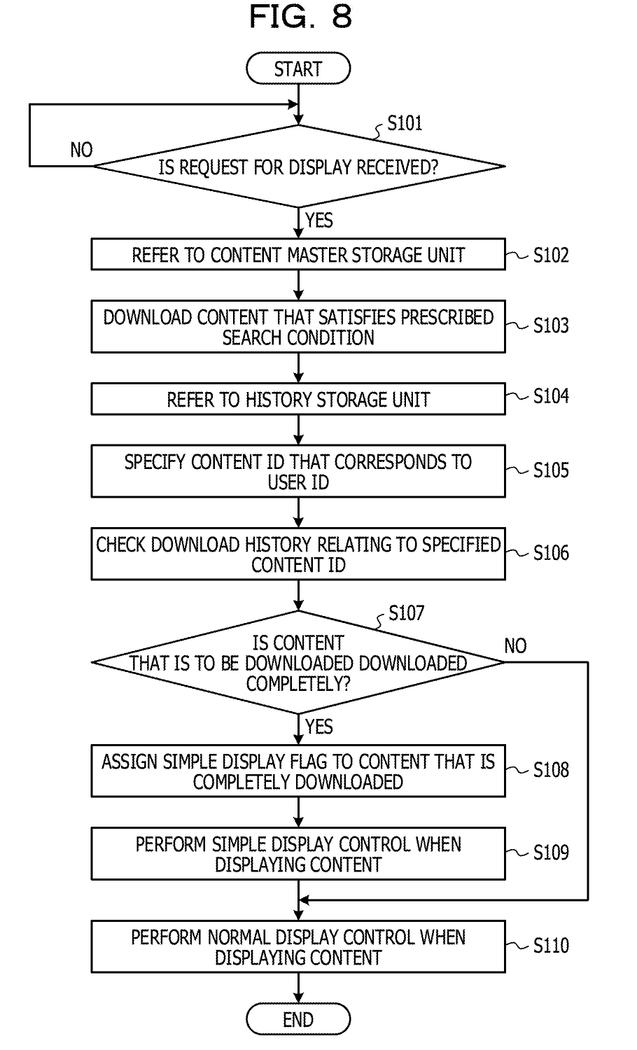

Subsequently, operation of the terminal device 100 will be described with reference to FIG. 8. Moreover, as described with reference to FIG. 7, in a case where the control unit 230 includes the content specification unit 231 and the display control unit 232, the operation of the server apparatus 200 may be illustrated in FIG. 8.

FIG. 8 is a flowchart illustrating an example of processing that is performed by the terminal device 100. First, as illustrated in FIG. 8, the content specification unit 131 waits until the request for the display is received (NO in Step S101). When receiving the request for the display (YES in Step S101), the content specification unit 131 refers to the content master storage unit 210 (Step S102), and downloads the content that satisfies a prescribed search condition (Step S103). For more detail, the content specification unit 131 downloads the list of the items of content that satisfy the prescribed search condition.

Subsequently, the content specification unit 131 refers to the history storage unit 220 (Step S104), and then specifies the content ID that corresponds to the user ID (Step S105). When the processing in Step S105 is completed, the content specification unit 131 checks download history relating to the specified content ID (Step S106), and determines whether or not the content that is to be downloaded is completely downloaded (Step S107).

At this point, in a case where the content that is to be downloaded is completely downloaded (YES in Step S107), and the content specification unit 131 assigns a simple display flag to the download-completed content (Step S108). The simple display flag is a control flag for simply displaying target content. If the processing in Step S108 is completed, the display control unit 132 performs simple display control when displaying the content on the display unit 150 (Step S109). That is, the display control unit 132 simply displays the content to which the simple display flag is assigned.

On the other hand, in a case where the content that is to be downloaded is not completely downloaded (NO in Step S107), or if the processing in Step S109 is completed, the display control unit 132 performs the normal display control when displaying the content on the display unit 150 (Step S110). That is, the display control unit 132 normally displays any other content to which the simple display flat is not assigned. Therefore, if the content to which the simple display flag is assigned is not included in the content that is displayed on the display unit 150, both the content that is controlled to be simply displayed and any other content that is controlled to be normally displayed are displayed on the display unit 150.

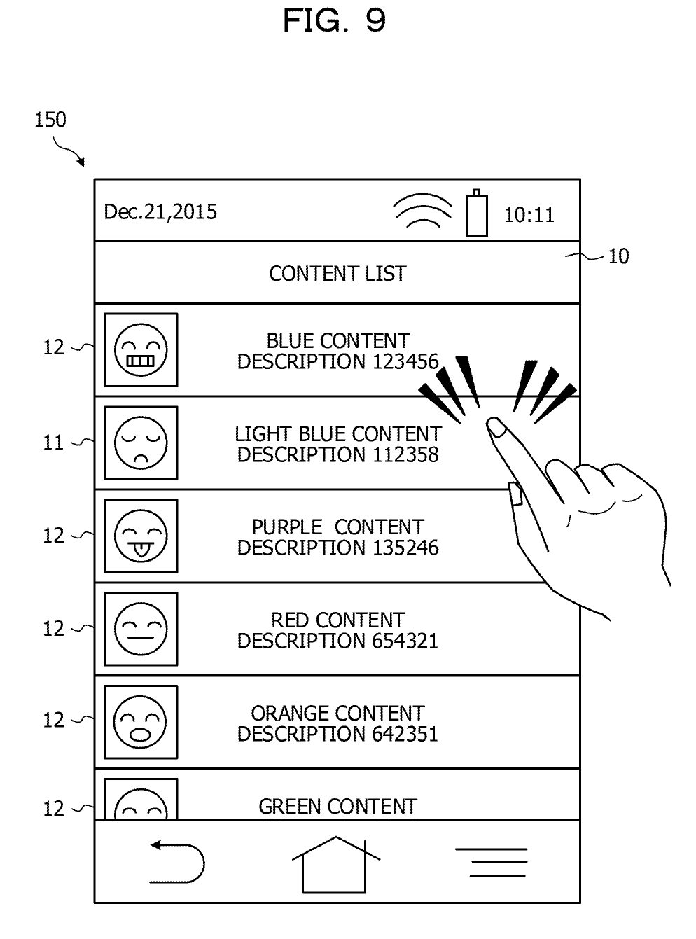

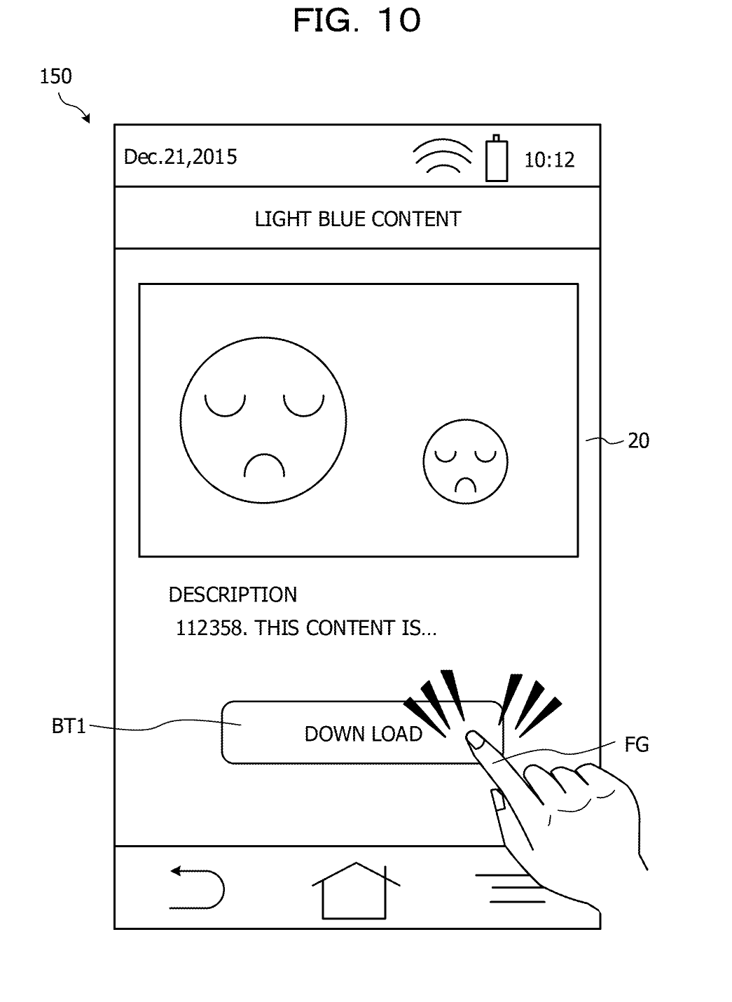

Subsequently, an example of an operation by the user and an example of screen transition will be described with reference to FIGS. 9 and 10.

FIG. 9 is an example of a content list screen 10. In FIG. 9, it is illustrated that content 11 and content 12 are not set to be simply displayed. FIG. 10 is an example of a download screen 20. For example, when the user who is assigned the user ID “U002” performs an operation of making a request for display of content that satisfies the search condition “content title=color content” to the operation application unit 120 in Dec. 21, 2015 (hereinafter referred to as a first date and time), the content specification unit 131 receives the request for the display of the content that includes the user ID and satisfies the search condition.

The content specification unit 131 refers to the content master storage unit 210 and then downloads the content that satisfies the search condition. Furthermore, based on the user ID, the content specification unit 131 refers to the history storage unit 220. At this point, if the history information in accordance with the user ID is not present in the history storage unit 220, the content specification unit 131 can neither specify the content ID, nor check the download history. Therefore, the content specification unit 131 determines that the content that is to be downloaded is not completely downloaded, and performs the normal display control when displaying the downloaded content on the display unit 150. Therefore, as illustrated in FIG. 9, the content list screen 10 on which the normal display control is performed on all items of content is displayed on the display unit 150. Moreover, the content list screen 10 is a screen for displaying the list of items of content.

At this point, as illustrated in FIG. 9, when a selection operation in which, for example, content that has the content title “light blue content” is selected with a finger FG on the content list screen 10 that is displayed on the display unit 150 is applied on the operation application unit 120, the operation application unit 120 transmits information relating to the selection operation to the content specification unit 131. Moreover, when receiving the information relating to the selection operation, the content specification unit 131 transfers the received information relating to the selection operation to the display control unit 132. When receiving the information relating to the selection operation that is transferred from the content specification unit 131, the display control unit 132 displays the download screen 20 for the selection content on the display unit 150. Therefore, as illustrated in FIG. 10, the download screen 20 is displayed on the display unit 150.

Moreover, as illustrated in FIG. 10, when a touch operation (a tap operation) is performed with the finger FG on a download button BT1 for downloading content on the download screen 20 that is displayed on the display unit 150, the touch operation is applied on the operation application unit 120. The download button BT1 is an image on which an operation is applicable. When the touch operation is applied on the operation application unit 120, the operation application unit 120 information relating to the touch operation to the content specification unit 131. When receiving the information relating to the touch operation, the content specification unit 131 downloads content that has the content title “light blue content.” When the download of the content is completed, the display control unit 132 the content in the DL content storage unit 110. For example, if the DL content storage unit 110 is stored in the favorite folder, the display control unit 132 registers the downloaded content in the favorite folder. When the display control unit 132 registers the content, the server apparatus 200 is notified of a registration date. Accordingly, the control unit 230 of the server apparatus 200 manages the registration date.

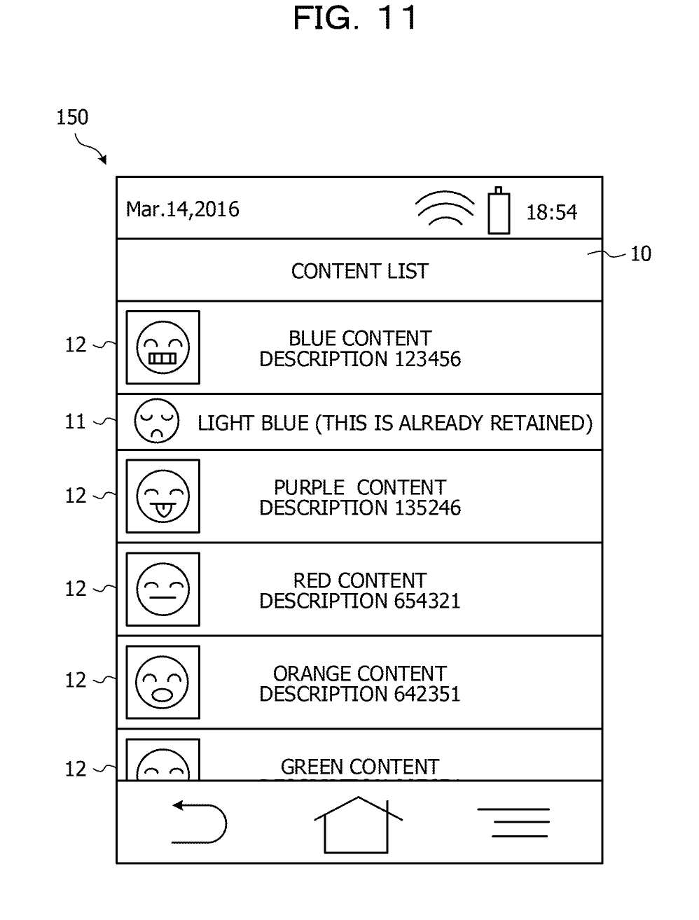

Subsequently, a case where an operation is performed that is the same as the operation which is performed at a second date and time (for example, in Mar. 14, 2016) that is later than the first data and time described above will be described with reference to FIG. 11. Moreover, with the operation that is performed at the first data and time, the user ID “U002”, the content ID “X2”, and the download date “Dec. 21, 2015” are stored in an associated manner, as the history information, on the history storage unit 220 (refer to FIG. 6).

FIG. 11 is another example of the content list screen 10. In FIG. 11, it is illustrated that one portion of the content is set to be simply displayed. When the user who is assigned the user ID “U002” described above performs the operation of making a request the display of the content that satisfies the search condition “content title=color content” to the operation application unit 120 at the second date and time, the content specification unit 131 receives the request for the display of the content that includes the user ID and satisfies the search condition.

The content specification unit 131 refers to the content master storage unit 210 and then downloads the content that satisfies the search condition. Furthermore, based on the user ID, the content specification unit 131 refers to the history storage unit 220. At this point, because the history information in accordance with the user ID is present in the history storage unit 220, the content specification unit 131 specifies the content ID and checks the download history. Therefore, the content specification unit 131 determines that content with the content ID “X2” is completely downloaded among items of content that are to be downloaded, and, when displaying the content with the content ID “X2” is displayed on the display unit 150, performs the simple display control. On the other hand, the content specification unit 131 determines that content other than the content with the content ID “X2” is not completely downloaded among the items of content that are to be downloaded, and, when such content is displayed on the display unit 150, performs the normal display control.

Therefore, as illustrated in FIG. 11, the content list screen 10, on which the simple display control is performed on the content 11 with the content ID “X2” and the normal display control is performed on any other content 12, is displayed on the display unit 150. As a result, a display area for the content 11 with the content title “light blue content” is smaller than that for any other content 12. In other words, the display area for any other content 12 is increased to be larger than that for the content 11. Moreover, a prescribed message (for example, “this is already retained” or the like) indicating the reason for the simple display may be included in the content 11 that is controlled to be simply displayed.

As described above, according to the first embodiment, the control unit 130 of the terminal device 100 includes the content specification unit 131 and the display control unit 132. When receiving the request for the display of the content that satisfies a prescribed search condition, the content specification unit 131 refers to the history storage unit 220 and then specifies the content that is associated with the user ID of the display request source. Furthermore, when displaying the content that satisfies the prescribed search condition, the display control unit 132 sets the display of the content that is associated with the user ID of the specified display request source, to be the simple display, and performs control that sets display of any other content to be the normal display, the display area for which is larger than that for the simple display. Accordingly, the content that is neither downloaded nor registered can be preferentially displayed. Therefore, by performing the operation a small number of times, the user can find a target content.

### Second Embodiment

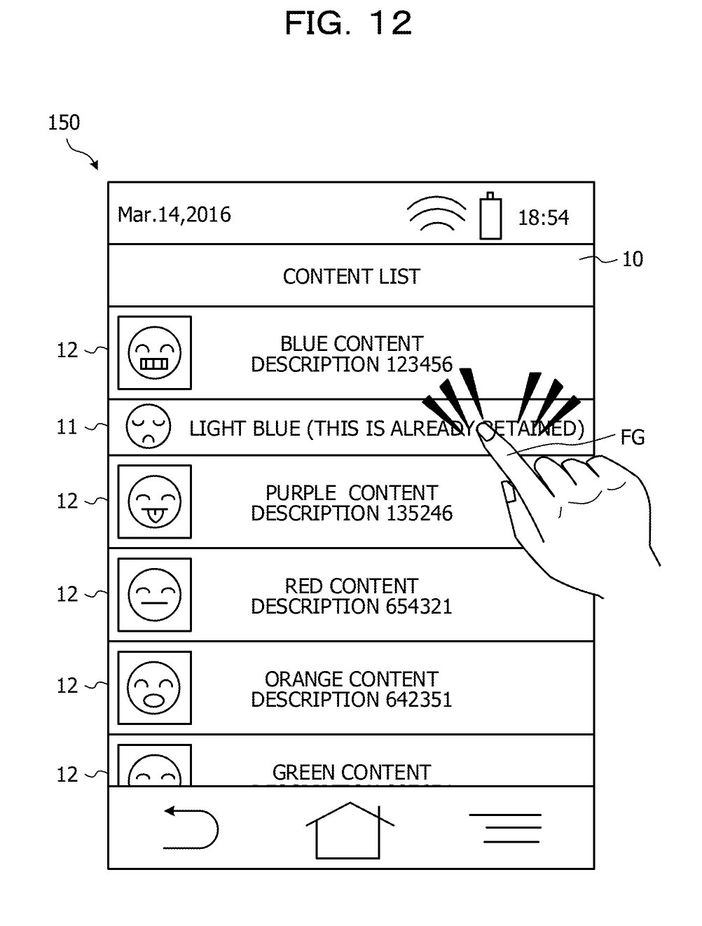

Next, another example of the user operation will be described with reference to FIG. 12. FIG. 12 is a diagram for describing the example of the operation with respect to the content that is controlled to be simply displayed. As illustrated in FIG. 12, a selection can be performed on the simple display in a simply displayed state, using the finger FG. For more detail, although the content 11 that is controlled to be simply displayed on the content list screen 10 and any other content 12 that is controlled to be normally displayed are present in a mixed manner, the content 11 can be selected in the same manner as any other content 12 is selected. Therefore, although the content 11 that is controlled to be simply displayed is present on the content list screen 10, the operability that is the same as the operability with respect to any other content 12 is secured.

Moreover, the display control unit 132 determines a size of the simple display based on a size of a screen area of the terminal device 100. On this occasion, the display control unit 132 performs control in such a manner that the simple display is so sized that a selection can be made or an operation can be applied at least in a simple display state. Accordingly, in the case of the smartphone, the simple display in accordance with a size of the smartphone appears on a screen of the smartphone, and in the case of the tablet terminal, the simple display in accordance with a size of the tablet terminal appears. In either case, the determination of the size of the simple display at which it is difficult to make the selection or to apply the operation in the simple display state is avoided. Furthermore, the display control unit 132 controls the size of the simple display according to the number of items of content that are displayed on the screen. For example, in FIG. 12, if the number of items of content 12 that are displayed on the screen is 4, the content 11 that is controlled to be simply displayed is displayed at a greater size than in the state that is illustrated in FIG. 12. Moreover, the display control unit 132 may control the size of the simple display in such a manner that items of content 12 of which the number is equal to or greater than a threshold (for example, 5) line up on the screen.

### Third Embodiment

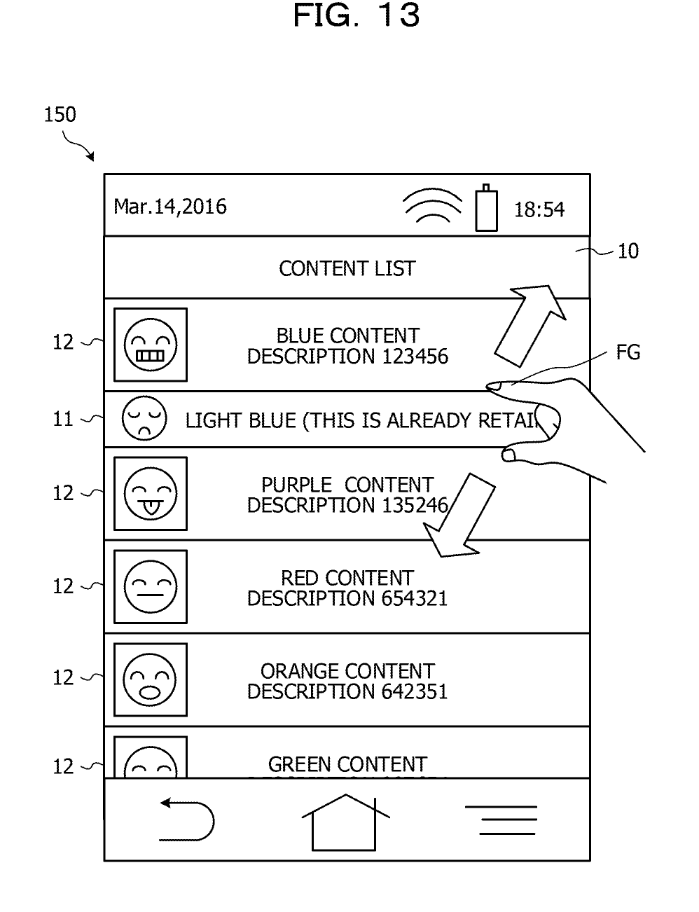

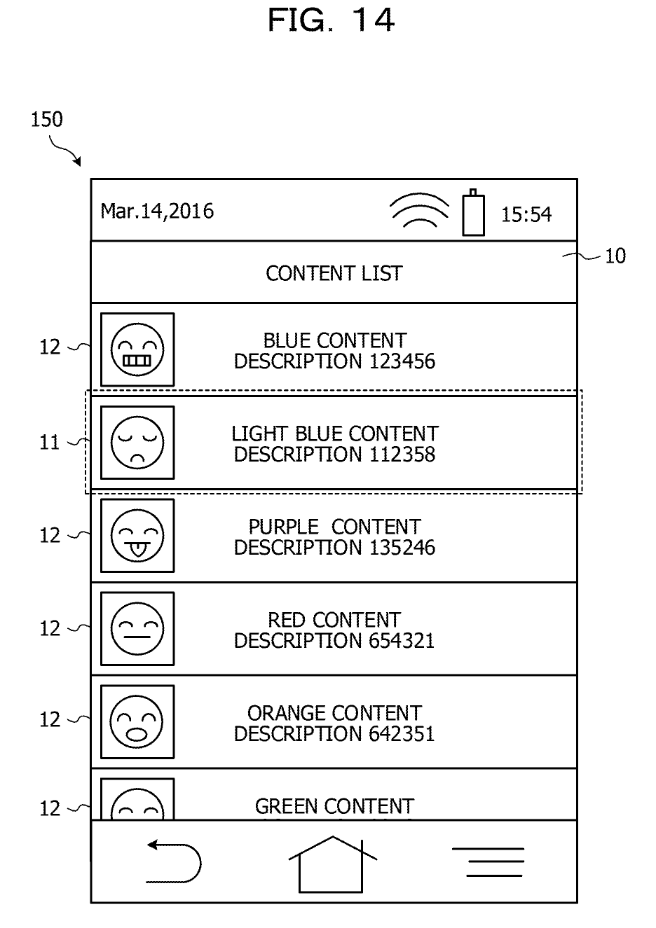

Next, another example of the user operation will be described with reference to FIGS. 13 and 14. FIG. 13 is a diagram for describing an example of a first operation with respect to the content 11 that is controlled to be simply displayed. In FIG. 13, a pinch open operation as the first operation is illustrated. FIG. 14 is an example of the content list screen 10 that is displayed after the first operation.

As illustrated in FIG. 13, when the pinch open operation is applied on the simple display, as illustrated in FIG. 14, switching to the normal display takes place. For more detail, when the pinch open operation is applied on the operation application unit 120 with the finger FG that comes into contact with the content 11 that is controlled to be simply displayed, the operation application unit 120 transmits information to the pinch open operation toward the display control unit 132. When detecting the pinch open operation, the display control unit 132 controls the content 11 that is controlled to be simply displayed, to be normally displayed. As a result, as illustrated in FIG. 14, the content 11 that is controlled to be normally displayed is displayed on the display unit 150. Moreover, as long as the first operation is identifiable, the first operation is not limited to the pinch open operation. For example, the first operation may be a double tap operation or the like.

### Fourth Embodiment

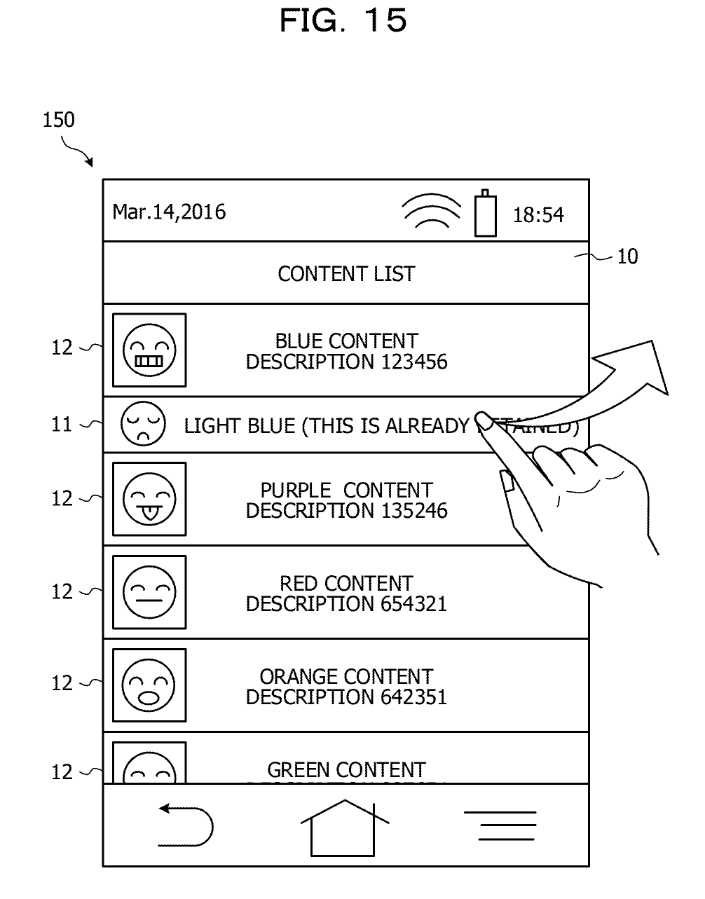

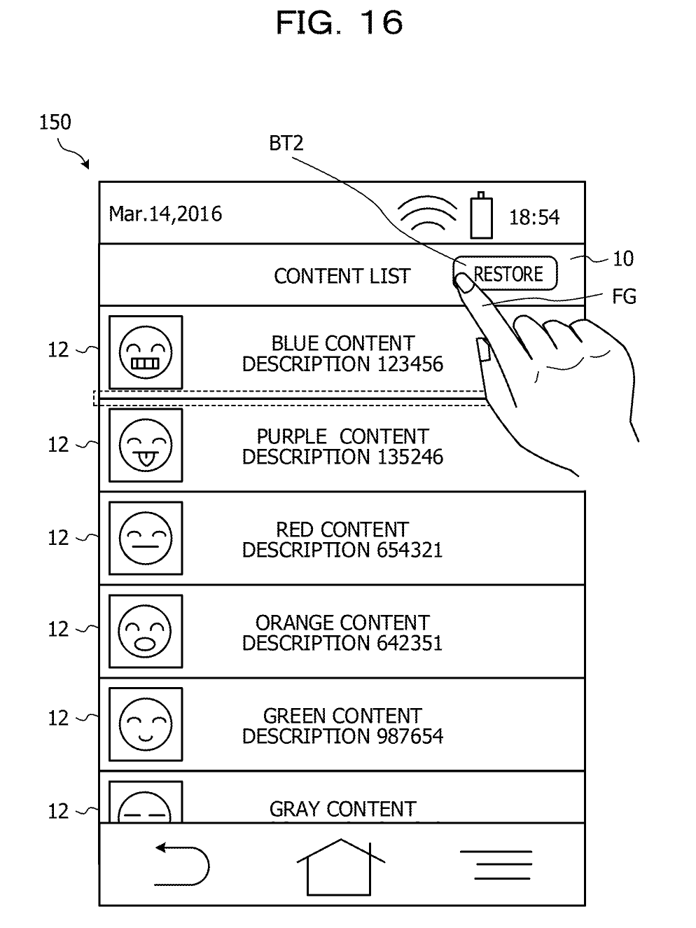

Next, another example of the user operation will be described with reference to FIGS. 15 and 16. FIG. 15 is a diagram for describing an example of a second operation with respect to the content 11 that is controlled to be simply displayed. In FIG. 15, an swipe operation or a slide operation (hereinafter referred to simply as the “swipe operation”) as the second operation is illustrated. FIG. 16 is an example of the content list screen 10 that is displayed after the second operation.

As illustrated in FIG. 15, when the swipe operation is applied on the simple display, the simple display disappears as illustrated in FIG. 16. For more detail, when the swipe operation is applied on the operation application unit 120 with the finger FG that comes into contact with the content 11 that is controlled to be simply displayed, the operation application unit 120 transmits information relating to the swipe operation toward the display control unit 132. When detecting the swipe operation, the display control unit 132 causes the content 11, which is controlled to be simply displayed, to disappear from the content list screen 10. As a result, as illustrated in FIG. 16, the content 11, which is controlled to be simply displayed, disappears from the content list screen 10. Therefore, any other content 12 that is controlled to be simply displayed is displayed on the display unit 150. Accordingly, the user finds target content more easily.

Moreover, in a case where the simply display disappears, as illustrated in FIG. 16, the display control unit 132 displays a restoration button BT2 for restoring the simple display that disappears, on an area other than a display area for any other content 12, of the content list screen 10. The restoration button BT2 is an image button on which an operation is applicable. When the touch operation is applied on the operation application unit 120 with the finger FG that comes into contact with the restoration button BT2, the operation application unit 120 transmits information relating to the touch operation toward the display control unit 132. When detecting the touch (tap) operation that is applied on the restoration button BT2, the display control unit 132 restores the content 11 that disappears from the content list screen 10. For more detail, the display control unit 132 displays the content 11 in the simple display state in a post-disappearance display position. Accordingly, although the content 11 disappears from the content list screen 10, the user can return to an original state (a state that is illustrated in FIG. 11).

### Fifth Embodiment

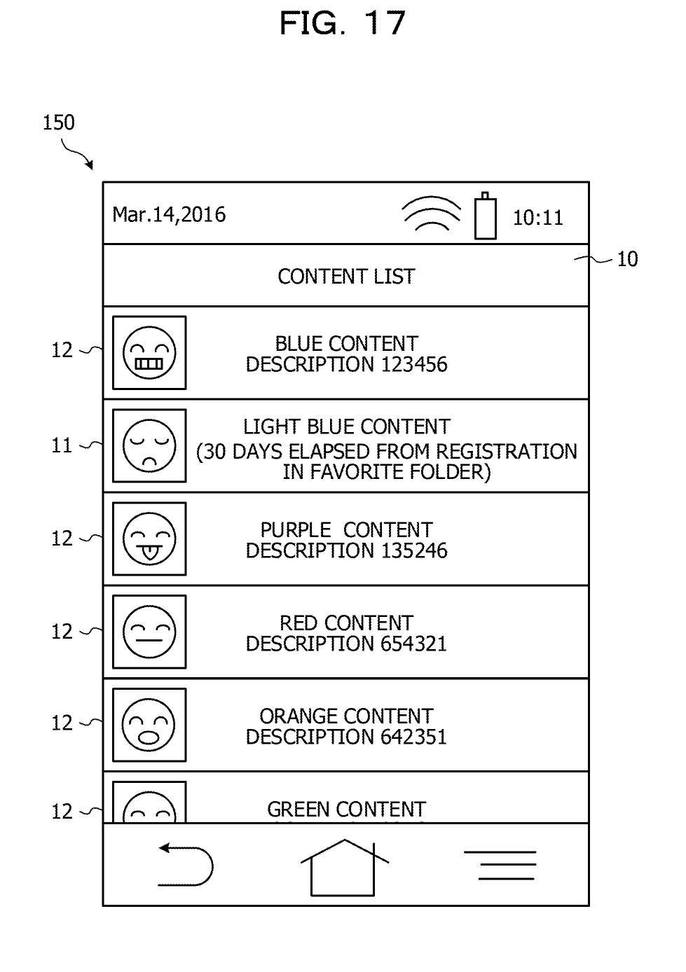

Next, another example of the display control will be described with reference to FIG. 17. FIG. 17 is another example of the content list screen 10. As described in the first embodiment, one item of content that satisfies a prescribed search condition is downloaded at the first date and time, and then the content may be registered in a registration destination (for example, a favorite folder) at the first date and time. At this point, in a state where the content is registered, when content that is the same as the content that satisfies the prescribed search condition is displayed at the second date and time, in a case where a prescribed time did not elapse from the registration, the display control unit 132 performs control that do not set the same content to be simply displayed. Examples of the prescribed time include several tens of days (for example, 30 days, several months (for example, three months), several years (for example, three years) and the like.

Because the content is already downloaded, the content is basically a control target for the simple display, but in the fifth embodiment, the control that does not set the content to be simply displayed is preferentially performed. For example, after the content is registered in the favorite folder, there is also a likelihood that the user will forget the fact that the content is registered. Therefore, the display control unit 132 performs control that does not set the content, from the registration of which a prescribed time elapsed, to be simply controlled. Accordingly, although the user forgets the fact that the content is registered, the user can be reminded of the fact that the content is registered. Moreover, a prescribed message (for example, “30 days elapsed from the registration” in the favorite folder or the like) may be included in the content 11 that is controlled not to be simply displayed.

### Sixth Embodiment

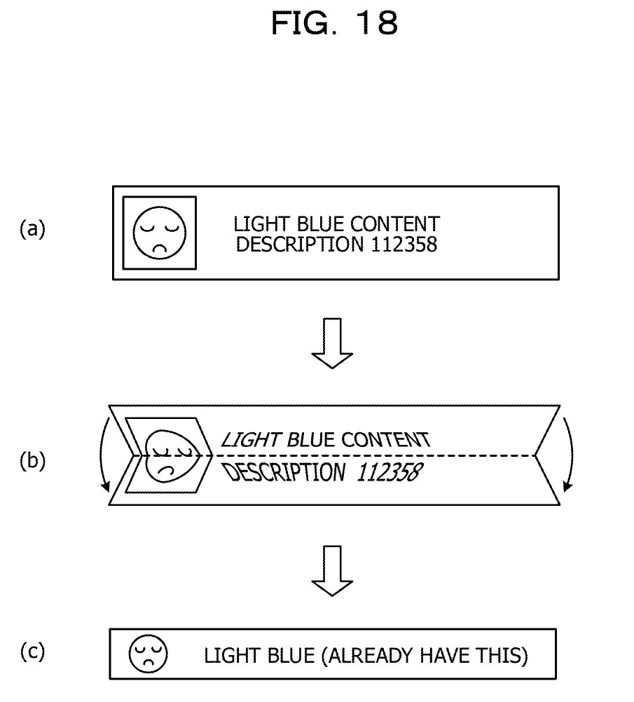

Next, a situation where the content 11 that is controlled to be simply displayed appears will be described with reference to FIG. 18. FIG. 18 is a diagram for describing an example of processing including controlling the content 11, which is controlled to be normally displayed, to be simply displayed. For more detail, when displaying the content 11, which is a target for the simple display, on the display unit 150, the display control unit 132, as illustrated in FIG. 18(a), first displays the content 11 for a prescribed time (for example, one second) for the normal display. After the prescribed time elapsed, as illustrated in FIG. 18(b), the display control unit 132 gradually displays a situation where the content 11 is being folded. Last, as illustrated in FIG. 18(c), the display control unit 132 displays the content 11 for the simple display. Accordingly, through a visual sensation, the user can quickly know the content that is already downloaded or registered. Moreover, one portion of the content title and a prescribed message that appear due to the simple display are displayed on the rear sides of the content name and the description that appear due to the normal display.

The desirable embodiments are described in detail, but no limitation to specific embodiments is imposed, and various modifications and alternations are possible within the scope of the gist of each of the embodiments that are claimed in claims. For example, in the first embodiment to the sixth embodiments, which are described above, the download may be paid for or be free of charge.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium recording a display control program which causes a computer to execute a processing, the processing comprising:
referring, when receiving a request for display of satisfied content that satisfies a condition, to a storage which stores user identification information, and download history information on content or registration history information on the content in association with each other;
specifying content that is associated with user identification information on a source of the request for display;
displaying the specified content in a simple display, from among the satisfied content; and
displaying other content on a normal display, on a display area that is greater than a display area for the simple display.

2. The non-transitory computer-readable recording medium according to claim 1,
wherein a selection is performed on the simple display in a simply displayed state.

3. The non-transitory computer-readable recording medium according to claim 1,
wherein the simple display is switched to the normal display when receiving a first operation.

4. The non-transitory computer-readable recording medium according to claim 1,
wherein the simple display disappears when receiving a second operation.

5. The non-transitory computer-readable recording medium according to claim 4,
wherein, when the simple display disappears, an image button on which an operation to restore the simple display that disappears is applicable is displayed on an area other than a display area for the satisfied content.

6. The non-transitory computer-readable recording medium according to claim 1,
wherein a size of the simple display is controlled in such a manner that the number of items of the satisfied content that are displayed on a screen is equal to or greater than a threshold.

7. The non-transitory computer-readable recording medium according to claim 1,
wherein, in a state where the satisfied content is registered in a registration destination after the satisfied content is downloaded, when content that is the same as the satisfied content is displayed, in a case where a time elapsed from the registration of the satisfied content in the registration destination, control is performed in such a manner that the same content is not displayed in the simple display.

8. The non-transitory computer-readable recording medium according to claim 1,
wherein, when displaying in the simple display is to be performed, a process from the normal display to the simple display is performed after displaying in the normal display.

9. A display control method comprising:
referring, by a computer, when receiving a request for display of satisfied content that satisfies a condition, to a storage which stores user identification information, and download history information on content or registration history information on the content in association with each other;
specifying content that is associated with user identification information on a source of the request for display;
displaying the specified content in a simple display, from among the satisfied content; and
displaying other content on a normal display, on a display area that is greater than a display area for the simple display.

10. The display control method according to claim 9,
wherein a selection is performed on the simple display in a simply displayed state.

11. The display control method according to claim 9,
wherein the simple display is switched to the normal display when receiving a first operation.

12. The display control method according to claim 9,
wherein the simple display disappears when receiving a second operation.

13. The display control method according to claim 12,
wherein, when the simple display disappears, an image button on which an operation to restore the simple display that disappears is applicable is displayed on an area other than a display area for the satisfied content.

14. The display control method according to claim 9,
wherein a size of the simple display is controlled in such a manner that the number of items of the satisfied content that are displayed on a screen is equal to or greater than a threshold.

15. The display control method according to claim 9,
wherein, in a state where the satisfied content is registered in a registration destination after the satisfied content is downloaded, when content that is the same as the satisfied content is displayed, in a case where a time elapsed from the registration of the satisfied content in the registration destination, control is performed in such a manner that the same content is not displayed in the simple display.

16. The display control method according to claim 9,
wherein, when displaying in the simple display is to be performed, a process from the normal display to the simple display is performed after displaying in the normal display.

17. An information processing apparatus comprising:
a memory; and
a computer coupled to the memory and configured to:
refer, when receiving a request for display of satisfied content that satisfies a condition, to a storage which stores user identification information, and download history information on content or registration history information on the content in association with each other;
specify content that is associated with user identification information on a source of the request for display;
display the specified content in a simple display, from among the satisfied content; and
display other content on a normal display, on a display area that is greater than a display area for the simple display.

18. The information processing apparatus according to claim 17,
wherein a selection is performed on the simple display in a simply displayed state.

19. The information processing apparatus according to claim 17,
wherein the simple display is switched to the normal display when receiving a first operation.

20. The information processing apparatus according to claim 17,
wherein the simple display disappears when receiving a second operation.
